(19) United States
(12) Patent Application Publication
(10) Pub. No.: US 2007/0152391 A1
(43) Pub. Date: Jul. 5, 2007

(54) Error corrected positioning stage

(76) Inventor: Anwar K. Chitayat, Fort Salonga, NY (US)

Correspondence Address: Thomas Spinelli, Jr.;Scully, Scott, Murphy & Presser, Ste. 300, 400 Garden City Plaza, Garden City, NY, 11530, US

(21) Appl. No.: 11/646,965

(22) Filed: Dec. 28, 2006

Related U.S. Application Data
(60) Provisional application No. 60/766,018, filed on Dec. 29, 2005.

(51) Int. Cl. B23Q 1/25

(52) U.S. Cl. 269/55

(57) ABSTRACT

A movable positioning apparatus for positioning a work piece, which includes a base having linear motors attached thereto for supporting and moving a stage or work piece in a longitudinal direction relative to the base. The apparatus includes two linear encoders to measure rotation error by calculating the difference in measured positions. An alignment laser measures straightness errors. Two slides control yaw by moving in opposite directions, and the slides control straightness by moving in the same direction.

### CROSS-REFERENCE TO RELATED APPLICATION

This application claims priority under 35 U.S.C. § 119(e) of U.S. Provisional Patent Application Ser. No. 60/766,018, filed 29 Dec. 2005, the complete disclosure of which is hereby incorporated by its reference for all purposes.

### BACKGROUND OF THE INVENTION

1. Field of Invention

The present invention relates to a linear positioning stage apparatus for use in the field of manufacturing technology, and more specifically relates to a linear positioning stage apparatus with automatic positioning and correction for rotation straightness.

2. Description of Related Art

In the manufacture of articles, particularly automated manufacture, it is expedient to position a raw material or work piece on a movable stage. The work piece is then positioned relative to a machine that performs some process on the work piece to advance or complete the manufacture.

Often, position tolerances for the manufacturing processes are critically tight. Therefore, there is a need for a positioning apparatus to achieve both superior accuracy and repeatability. For example, current positioning stage apparatuses provide accuracy and repeatability for small scale work pieces. In current designs, accuracy requires very stiff and stable members that must be machined to strict tolerances. One disadvantage of the strict tolerances is that fewer machining centers are capable of producing the required tolerances, and are thus more difficult to find and more expensive to produce the positioning stage. Further disadvantages of current attempts to enhance accuracy of positioning apparatuses includes designing a positioning apparatus which becomes excessively large and heavy which adds to the costs of the apparatus from, for example, required building material, manufacture and machining, transporting, and location of use.

Therefore, increasing the size of a conventional positioning apparatus results in shortcomings and disadvantageous, and further, does not adequately scale up to accommodate larger size work pieces. For larger work pieces, for example, those on the order of one to several square meters, a positioning apparatus of necessary precision and accuracy would be excessively massive, heavy and difficult to construct, and also difficult to assemble or calibrate particularly on-site.

Attempts to remedy the problems described above have heretofore been unsuccessful. For example, an error map may be created which depicts the positioning of a work piece and errors made in the processing of the work piece after a plurality of completed tasks by a positioning apparatus. However, even if corrections are implemented based on the error map, the current machines generally are not capable of repetition, and for example, low cost machines generally tend to distort with time and consequently do not repeat. Moreover, any change in temperature can change the position of the work piece due to the different coefficients of expansion of materials used, so that error mapping changes appreciably. A further problem with error mapping occurs if excessive force such as a crash or electronic failure moves the rails or the mounting of the parts, in such a case, a new error map must be developed. Another problem with error mapping pertains to the cost and the time in obtaining a master plate or other means for calibration of the apparatus in the field.

Therefore, a need exists in the art for a positioning apparatus which can position a large work piece with accuracy and precision, while also being of a manageable size and weight.

### BRIEF SUMMARY OF THE INVENTION

In the present invention, a movable positioning apparatus for positioning a work piece comprises one or more linear motors coupled to a base for supporting and moving one of a stage or work piece relative to the base in a longitudinal direction defined by a substantially longitudinal axis. A first detection device is coupled to the base and communicates with the stage or work piece for detecting a first deviation in a first direction. A second detection device is coupled to the base and communicate with the stage or work piece for detecting an average of the first deviation or the angular deviation. One or more actuators are coupled to the base and communicate with one of the stage or work piece for correcting a position of one of the stage or the work piece by the amount of the first deviation and a second deviation.

In a related aspect, the one or more actuators correct the position of the work piece by moving the work piece laterally in relation to the longitudinal axis.

In another related aspect, the one or more actuators correct the position of the work piece by moving the work piece rotationally.

In a further related aspect, the first direction is substantially lateral in relation to the longitudinal axis.

In a further related aspect, the one or more second detection devices detect an average of the first deviation.

In a further related aspect, the one or more second detection devices detect an average of a second deviation in a second direction from a second specified position, and the one or more actuators correct the position of one of the stage or work piece by the amount of the second deviation.

In a further related aspect, the one or more linear motors, the first and second detection devices and the one or more actuators communicate with a servo controller device for calculating the first deviation and initiating the correcting of the position of the stage or the work piece using the actuators.

In a further related aspect, the servo controller includes a computer having a computer program for calculating the first deviation.

In a further related aspect, the one or more of second detection devices include one encoder which measures the position of the stage or work piece from an end of the base and another encoder which measures the position of the stage or work piece from an opposite end of the base.

In a further related aspect, the one or more actuators communicate with a plurality of flexible bushings supporting the stage or work piece such that the flexible bushings resiliently move in a lateral direction in relation to the longitudinal axis to correct the position of the stage or work piece.

In a related aspect, the apparatus comprises a second detection device coupled to the base and communicating with the stage or work piece for detecting a second deviation in the first direction in spaced relation from the first detection device.

In a related aspect, the apparatus further comprises a controller for measuring a difference between the first and second devices which measures rotation of the stage relative to the longitudinal axis.

In a related aspect, the apparatus further comprises two actuators coupled to the base or the work piece. The actuators move the stage laterally relative to the longitudinal axis, and the actuators provide rotation of the base or work piece by moving in opposite directions.

In a related aspect, each actuator contains a motor and amplifier which automatically moves to correct for rotational errors sensed by two detecting devices.

In a related aspect, the apparatus further comprises a third detection device for measuring lateral displacement from the longitudinal axis, and two actuators coupled to the base or the work piece move the stage laterally relative to the longitudinal axis to correct for the lateral displacement measurement.

In a further related aspect, two linear motors each coupled to substantially parallel motor rails extending in the longitudinal direction and communicating with a servo controller device to support and move one of the stage or the work piece in the longitudinal direction. Two actuators ride along respective substantially parallel rails coupled to the base and extend in the longitudinal direction. The two actuators communicate with the servo controller and are adapted to move the stage or cross slides laterally in unison or individually. The second detection devices include two encoder devices slidably coupled to respective parallel encoder scales extending in the longitudinal direction and each of the two encoders communicating the position of the work piece to the servo controller which calculates an average position and initiates a corrective movement of the stage or work piece using the actuators by the amount of the first deviation. The first detection device includes an alignment laser and detector to measure the first deviation in the first direction (straightness (cross axis error)) and communicates with the servo controller which initiates the corrective movement of the stage or work piece via the two actuators.

In another aspect of the present invention a method of positioning a work piece comprises providing a base and supporting and moving either the stage or work piece relative to the base in a longitudinal direction defined by a substantially longitudinal axis. A first deviation is detected in a first direction of the stage or work piece. An average of the first deviation is calculated from one or more position encoders. A position of either the stage or the work piece is corrected by the amount of the first deviation.

In another aspect of the present invention, a method of positioning a work piece comprises providing a base and supporting and moving either the stage or work piece relative to the base in a longitudinal direction defined by a substantially longitudinal axis. A first deviation is detected in a first direction of the stage or work piece. An average of the first deviation is calculated from one or more position encoders. A position of either the stage or the work piece is corrected by the amount of the first deviation.

In a related aspect, the stage is substantially supported by at least three air lifters riding on longitudinally extending beams.

In a related aspect, the step of correcting the position of the stage or work piece includes moving the work piece laterally in relation to a longitudinal axis.

In a related aspect, the step of correcting the position of the stage or work piece includes moving the work piece rotationally.

In another aspect of the invention, a computer program product is embodied in a computer-readable medium for positioning a work piece or stage, where the program comprises the steps of receiving and recording a first deviation signal in a first direction of a stage or work piece from a first detection device coupled to a base and communicating with the stage or work piece. The stage or work piece is supported by one or more linear motors coupled to the base which moves the stage or work piece in a longitudinal direction defined by a substantially longitudinal axis. An average of the first deviation is calculated from comparing positioning data of the work piece or stage sent from one or more of second detection devices coupled to the base and communicating with the stage or work piece to a specified position of the stage or work piece. A correction of a position of the stage or the work piece is initiated by the amount of the first deviation using one or more actuators coupled to the base and communicating with the stage or work piece.

In a related aspect, the computer program product of further comprises the step of initiating movement of the stage or work piece in the longitudinal direction using the one or more linear motors to move the stage or work piece to a first specified position or to correct for an error in longitudinal positioning of the stage or work piece.

In a related aspect, the computer program stores and uses maps of errors and positioning data to correctively move the work piece via the actuators.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a perspective view of a positioning apparatus according to an embodiment of the invention;

FIG. 2 is a plan view of the positioning apparatus shown in FIG. 1;

FIG. 3 is a detail side elevational view of a linear motor used in the positioning apparatus shown in FIGS. 1 and 2;

FIG. 4 is a detail side elevational view of a motorized slide assembly shown in FIGS. 1 and 2;

FIG. 5 is a detail side elevational view of a non-motorized slide assembly shown in FIGS. 1 and 2;

FIG. 6 is a side elevational view of an embodiment of an actuated flexure bushing;

FIG. 7 is a side elevational view of the actuated flexure bushing shown in FIG. 6 moving in a lateral direction;

FIG. 8 is a plan view of another embodiment of the positioning apparatus according to the invention which uses airbearings instead of rails;

FIG. 9 is a side elevational view of an air bushing shown in FIG. 8;

FIG. 10 is a plan view of another embodiment of the positioning apparatus according to the invention which includes air bearing along rails; and

FIG. 11 is a detail side elevational view of the air bearing shown in FIG. 10.

### DETAILED DESCRIPTION OF THE INVENTION.

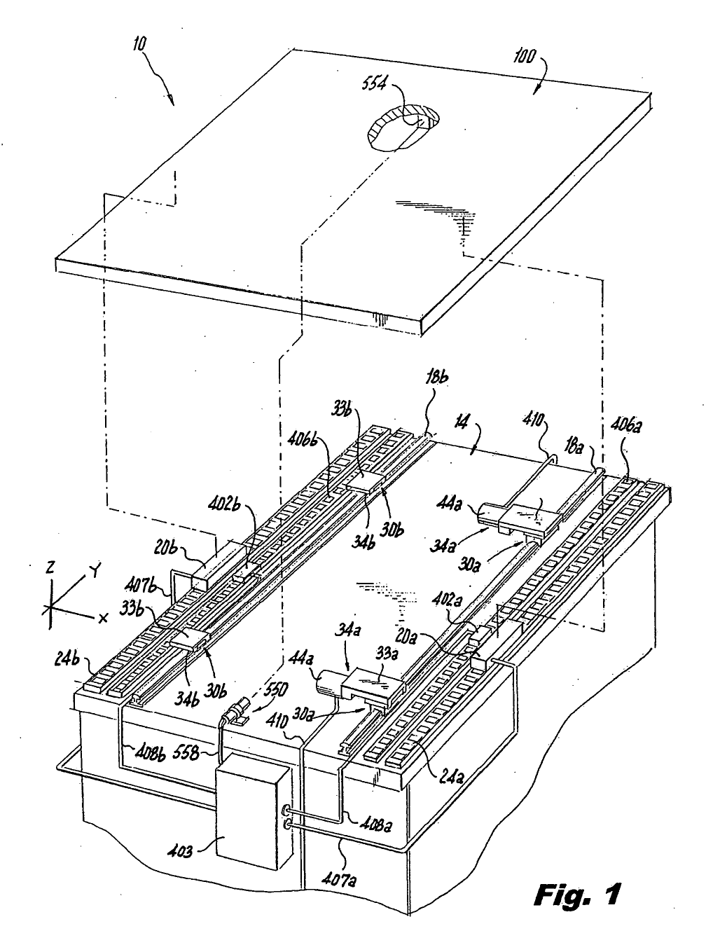

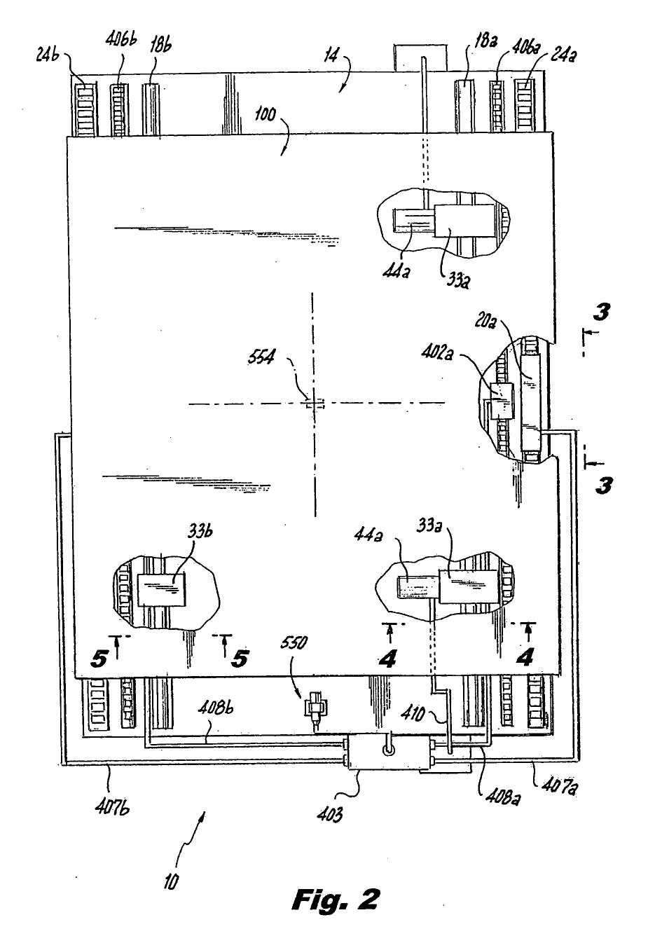

Referring to FIGS. 1 -3, a positioning apparatus 10, according to a first exemplary embodiment of the present invention comprises a base or undercarriage 14, and includes frame rails 18a and 18b extending in a “Y” direction in relation to a longitudinal axis (shown in FIG. 2). The frame rails 18a, 18b allow movement in the “Y” direction for carting or moving a movable stage 100. The frame rails 18a, 18b may also support a work piece directly. The base or undercarriage 14 provides a platform for other components of the positioning stage apparatus 10 which will be described below. Two linear motors 20a, 20b are mounted on top of magnet assemblies 24a, 24b, respectively, extending in the “Y” direction in relation to the longitudinal axis, and positioned on each side of the base 14 of the stage apparatus 10. It is possible that one linear motor, either 20a or 20b may suffice for a specific application, or either or both linear motors 20a, 20b may be replaced by a lead screw with rotary motor or a pneumatic or hydraulic powered actuator. The linear motors 20a, 20b are connected to a servo controller 403 via lines 407a and 407b, respectively.

More specifically, the frame rails 18a and 18b are substantially parallel and are attached to the base 14 of the positioning stage apparatus 10. Two bushings 30a slide along rail 18a and two bushings 30b slide along rail 18b. All four bushings 30a, 30b ride freely along the rails 18a, 18b, respectively. Positioned on top of each of the four bushings 30a, 30b are slides 34a, 34b. Two slides 34a are positioned on top of the bushings 30a on rail 18a, and two slides 34b are positioned on top of the bushings 30b on rail 18b. The slides 34a, 34b allow motion laterally with respect to the longitudinal axis (in the “X” direction in relation to an “X” axis shown in FIG. 2).

Referring to FIG. 4, a representative bushing 30a mates with a bulbous portion 19 of the rail 18a. Thereby, the bushings 30a are slidably coupled to the rail 18a and are free to move along the rail 18a in the “Y” direction. The bushings 30a, 30b may include a low friction material and slide directly on the rail, or may include for example a linear ball bushing. The slides 34a on rail 18a are motorized using motors 44a, while slides 34b on rail 18b are not motorized and can move freely along the “X” axis. As will be described below and shown in FIG. 4, the motors 44a move the slides 34a and can move the stage 100 laterally and angularly.

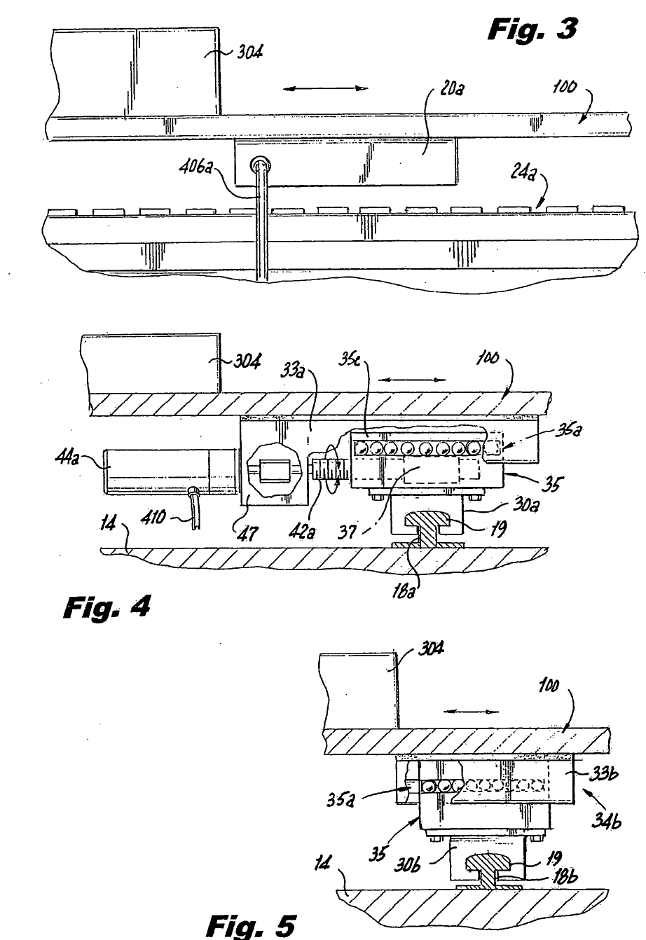

Specifically, referring to FIG. 4, the slides 34a on rail 18a include a screw 42a connected to the motor 44a. The motor 44a spins the screw 42a which moves a top portion 33a of the slide 34a. A top portion 33a of the slide 34a surrounds the body 35 of the slide and is movably bracketed to the motor 44a using flange 47. The top portion 33a of the slide is also mounted over ball bearings 35a in the body 35 of the slide 34a to facilitate smooth lateral motion of the top portion 33a of the slide 34a. Within the body 35 of the slide 34a, which non-motorized part are representative of slide 34b as well, the screw 42a mates with a nut 37 (shown in phantom in FIG. 4) inside the body 35 of the slide 34a. The slides 34a on rail 18a are motorized using motors 44a, while slides 34b on rail 18b (shown in FIGS. 1 and 5) are not motorized and can move freely in the “X” direction such that when a work piece or stage is positioned on all four slides 34a, 34b the slides 34b freely move in the “X” direction in concert with the motor driven slides 34a.

Referring to FIG. 1, if both slides 34a are moved in the same direction using the motors 44a the stage 100 positioned on the slides 34a and slides 34b will move laterally along the “X” axis. However, if one of the slides 34a via the motor 44a moves in one direction along the “X” axis and the other slide 34a via the motor 44a moves in the opposite direction, the movable stage 100 will rotate either in the clockwise or counter clockwise direction. In this manner, rotation as well as “X” axis movement can be effected by either commanding the motors 44a and slides 34a to move together or opposite to each other. The motor 44a with associated screw 42a, shown in FIG. 4, can be replaced by a linear motor, pneumatic or hydraulic actuator, or a piezoelectric element. The slides 34a 34b can include a rotary or linear encoder to measure position of the stage, in order to provide feedback to the controller.

In another embodiment of the positioning apparatus, the base 14 (shown in FIGS. 1 and 2) is very rigid, and the stage 100 errors are repeatable and measurable in terms of rotation and straightness. The errors in rotation are measured by using an autocollimator, or laser interferometer. The errors versus longitudinal positions are tabulated in a table (or map) which is then entered into the memory of a computer. Another table (or map) is generated comprising the errors in the cross direction (straightness), and also entered into the memory of the computer. During normal operation, the measuring equipment is removed and the map automatically introduces the correction. In this embodiment, the memorized errors in rotation are used to move the two slides 33a in the opposite direction to compensate for the memorized rotational errors. Also, the memorized errors in the cross direction are used to move the slides 33a in the same direction to compensate for the cross directional errors.

Referring to FIGS. 3-5, for certain applications of the present invention, a work piece 304, i.e., the article upon which operations are being performed, will be supported and moved directly by the movable stage 100 shown in FIG. 1. In alternate embodiments, a platform (not shown) can be provided above the movable stage 100, and the work piece 304 is supported by the platform. The operation of the stage positioning apparatus 10 and the movable stage 100 is not materially affected by the distinction, and description herein is generally given with respect to direct attachment of the work piece 304 to the movable stage 100, except where the distinction is made.

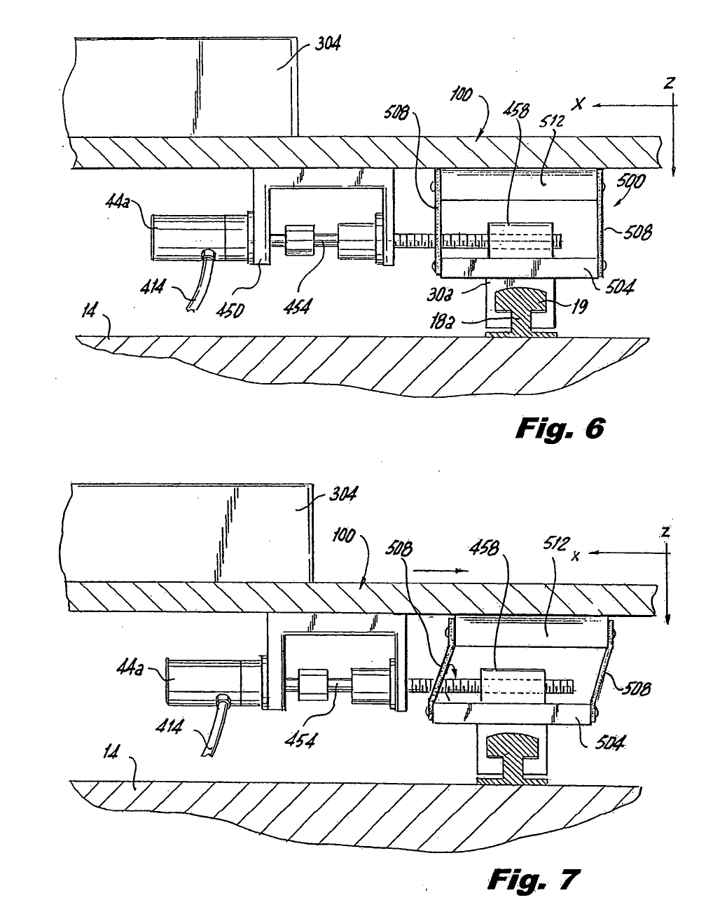

Referring to FIGS. 6 and 7, an alternative embodiment of the motorized slides 34a is shown, in which similar parts can also be applied to the non-motorized slides 34b. A flexible bushing 500 may be used to replace slides 34a and 34b. As shown in FIG. 6, a frame 450 is mounted to the motor 44a which braces a threaded shaft 454 passing through it. A nut 458 is connected to a distal end of the shaft 454 and moves in the “X” direction as the shaft 454 is rotated by the motor 44a. A flexible bushing 500 includes top member 512 and bottom member 504 held in spaced relation by flexible side walls 508. The bottom member 504 mates with the bushing 30a riding on rail 18a. The side walls 508 of the flexible bushing 500 are sufficiently rigid to support a design load or force along the Z-axis, while providing flexibility to adjust in the X-axis. The flexure bushing 500 may be used to replace the slides 34a when the lateral motion is small. The motor 44a may be replaced, for example, by a piezoelectric actuator attached to the flexure bushing.

In operation, referring to FIGS. 6 and 7, the nut 458 contacts the flexible side wall 508 and moves the top member 512 as the shaft extends when rotated by the motor. The stage 100 is thereby moved in a lateral direction with the top portion 512 of the flexible bushing 500. The side walls 508 of the flexible bushing 500 are sufficient rigidly even in their flexed position, shown in FIG. 7, to support the design load or force along the Z-axis. The threaded shaft 454 is rotated by the motor 44a, moving the nut 458 which is attached to the base 14. The slide 100 moves to flex the flexible walls 508 as shown in FIGS. 6 and 7.

Referring to FIG. 1, linear encoders 402a and 402b are mounted on glass scales 406a and 406b, respectively, to determine the position of the movable stage 100 along the “X” axis and may also be used to determine the position of the movable stage 100 along the “Y” axis. A conventional linear encoder is a sensor, transducer or read head paired with a scale that encodes position. Linear encoders as known in the art and are generally inexpensive and dependable in encoding position. Therefore, any error in the encoders 402a and 402b may be mapped on installation, and taking into consideration in computing true position. The distance between frame rails 18a, 18b is generally dictated by the size of a work piece or the stage 100, but is at least great enough with reference to the resolution of encoders 402a, 402b, that any difference measured between the encoders can be used to derive an angular deviation of the work piece 304 around the Z-axis. More specifically, each encoder 402a, 402b can be moved along their respective scales 406a and 406b. Each encoder is connected to the servo-controller 403 by lines 408a, 408b, respectively, which monitors the position of the work piece or stage. The servo controller 403 calculates the average position using the two encoder position inputs. The average position can be compared to a specified position recorded in the servo controller 403. The servo controller 403 may run a program or be connected to a computer which runs a program for receiving, calculating and initiating motion of the linear motors 20a, 20b, and the slide motors 44a.

Also shown in FIG. 1 is independent alignment detection, for example, an alignment laser 550 and target 554. Alignment lasers are well known and manufactured, for example, by the On-Track™ company. As an alternate method of an alignment laser, a laser interferometer with straightness measuring optics can be used, which are manufactured, for example, by the Renishaw™ company. These methods provide an error signal proportional to the displacement of the sensor from a perfect straight line. The present invention uses this error to automatically compensate for these errors, by moving the top portions 33a of the slides 34a, resulting in a highly improved order of accuracy. Referring to FIG. 1, the laser alignment according to the illustrative embodiment of the present invention includes a target or detector 554 which may be an optical target or a sensor coupled to the movable stage 100, with position error detection capability in either one or two axes, in the present embodiment the X-axis, or X and Z axis.

In use, positional error in the X-axis detected at target 554 will be corrected by a lateral displacement of the top portions 33a of the slides 34a in the same direction. Any rotation about the Z-axis is detected by a differential in the position indications between encoders 402a and 402b, and is corrected by moving the top portions 33a of the slides 34a in opposite directions.

In general, the range of motion of actuators top portions 33a of the slides 34a is quite small, on the order of about 100 microns to achieve the positional fine tuning necessary. However, the range can be much larger in order to intentionally generate an angular displacement. In this case, it may be necessary to provide means of rotation such as rotary flexures or standard rotary bearings on both slides 34a. However, when the motion is small, the compliance of the stage members allows for slight rotation.

It will be appreciated, however, that other forms of linear actuation may be substituted without departing from the scope of the present invention. For example, an actuator may include a piezoelectric element which converts voltage input to linear motion, in order to active any desired movement in the X-axis. Moreover, types of actuators may be intermixed.

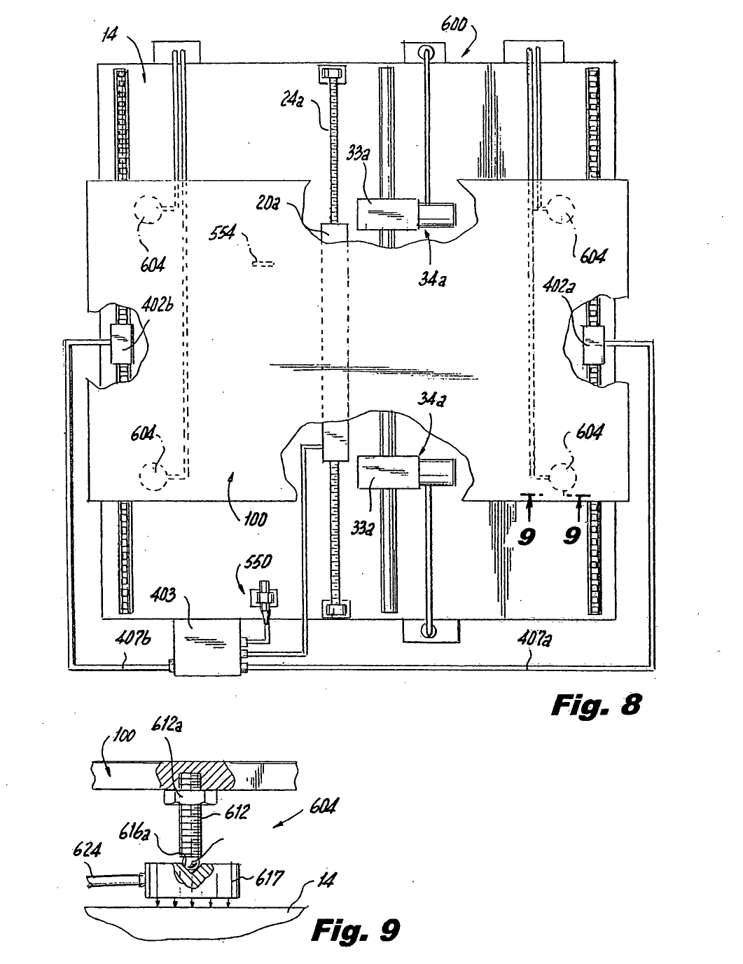

In another embodiment of the positioning apparatus 600 according to the invention, shown in FIGS. 8-9, four air lifters 604 (air bearings) are used to lift the stage 100 or a work piece (not shown). The air lifters 604 support the weight of the stage.

Referring to FIGS. 8 and 9, the air lifters 604 are known in the art. They receive air from a compressor through a tube 624 attached to each bearing. A minimum of three air lifters 604 are required to lift the stage 100 above the base 14. Four air lifters 604 are used in the embodiment shown in FIG. 8.

Referring to FIG. 9, the air lifters 604 include a threaded shaft 612 coupled to the work piece 100 using nut 612a. The air lifter 604 is connected to an air supply by hose 624. A ball bearing 616 rides in groove 616a. The base 617 receives pressurized air via hose 624 to support the stage 100. Similar to apparatus 10 shown in FIG. 1, the two encoders 402a, 402b record the positioning of the stage and are connected to servo controller 403. The motorized slides 34a ride on rail 18a and are attached to the base 14 in an off-centered position. The apparatus 600 uses only the motorized slides 34a and one substantially centered linear motor represented by linear motor 20a shown in FIGS. 1 and 8. The apparatus 600 operates in a similar manner to the positioning apparatus 10 shown in FIG. 1 with the air lifters 604 providing support for the stage or work piece as it is moved to desired positions.

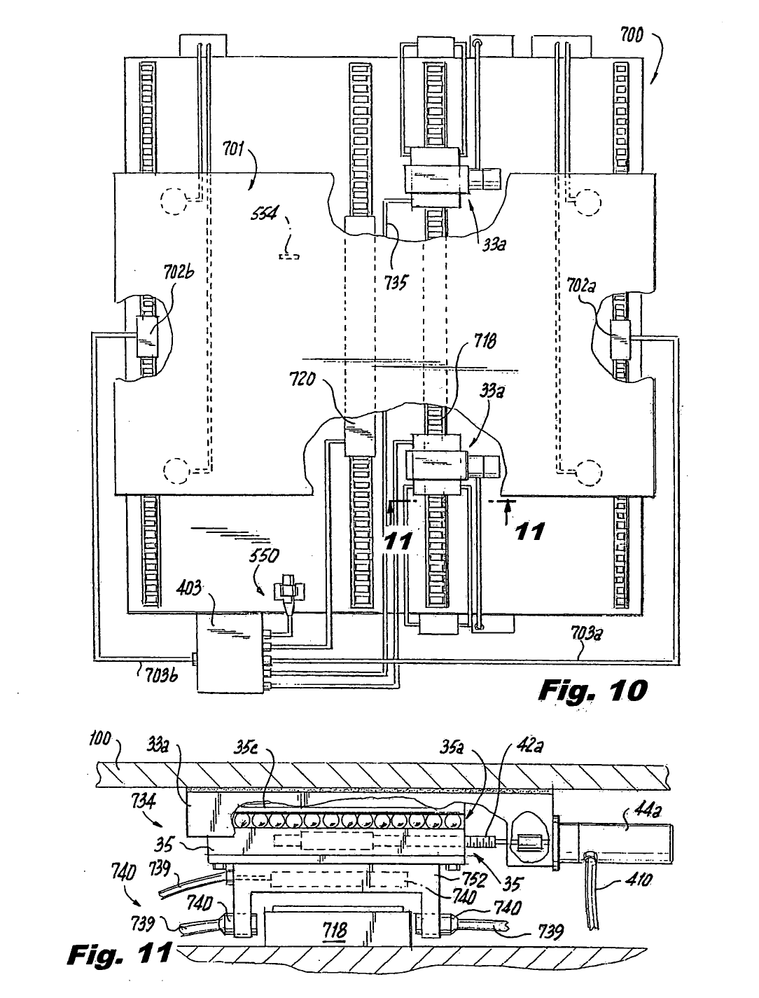

Referring to FIGS. 10 and 11, similar to apparatus 10 shown in FIG. 1, two encoders 702a, 702b determine the position of the stage 701 by calculating the average position and are connected to servo 403 via lines 703a, 703b, respectively. The encoders 702a, 702b determine the rotation of the stage 701 by calculating the difference in the detected positions. Two motorized slides 33a ride on a rectangular rail 718 with air bearing guides 740 as shown in FIG. 10 and 11, and are connected to the servo 403 via lines 735. Each guide 740 includes a frame 752 having attached at least two air bearings 740 which straddle the rail 718 and receive pressurized air via hoses 739. On top of each of the two guides 740 are two slides 33a with motors 44a previously shown in FIG. 4. As shown in FIG. 8, a straightness laser 550 and sensor 554 are used to detect straightness errors which are corrected by moving slides 33a in the same direction. Any error in rotation is sensed by the difference of the two encoders 702a, 702b and can be used to move the slides 33a in opposite directions. The apparatus 700 operates in a similar manner to the positioning apparatus 10 shown in FIG. 1 with the air lifters 740 providing support for the stage 701 as it is moved to a desired position.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A movable positioning apparatus for positioning a work piece, which comprises:
a base;
one or more linear motors coupled to the base for moving a stage or work piece relative to the base in a longitudinal direction defined by a substantially longitudinal axis;
a first detection device coupled to the base and communicating with the stage or work piece for detecting a first deviation in the longitudinal direction;
a second detection device coupled to the base and communicating with the stage or work piece for detecting a second deviation in the longitudinal direction at a distance relative to the first detecting device;
a controller that measures a difference between the first and second deviations by the first and second detection devices, respectively, to determine a rotation measurement of the stage relative to the longitudinal axis;
two actuators coupled to the base or the work piece that move the stage laterally in relation to the longitudinal axis to provide rotation in response to the rotation measurement by moving the two actuators opposite to each other;
each of the two actuators including a motor and amplifier that automatically corrects for the rotational measurement;
a third detection device measures the lateral displacement of the base or work piece along the longitudinal axis and initiates the two actuators in the same direction to compensate for a detected error.

2. The apparatus of claim 1, wherein the stage is supported by at least three bushings riding on two rails positioned in the longitudinal direction wherein at least two of the bushings ride on one of the two rails;
the two actuators ride on a top surface of two bushings along one rail; and
at least one slide rides on a top surface of a third or more bushings to allow for the lateral displacement of the stage or work piece.

3. The apparatus of claim 1, wherein the stage is supported by at least three air lifters;
two guides ride on substantially rectangular beams positioned in the longitudinal direction, and the two actuators ride on a top surface of the two guides.

4. The apparatus of claim 2, wherein an average of the first and second deviations from the first and second detection devices, respectively, is used to move the stage longitudinally using the one or more linear motors.

5. The apparatus of claim 2, wherein the third detection device includes an alignment laser with a cross axis measuring device to provide a straightness error measurement.

6. The apparatus of claim 4, wherein the third detection device includes an alignment laser with a cross axis measuring device to provide a straightness error measurement.

7. The apparatus of claim 3, wherein the average of the first and second deviations from the first and second detection devices, respectively, is used to move the stage longitudinally using the one or more linear motors.

8. The apparatus of claim 3, wherein the third detection device consists of an alignment laser with a cross axis measuring device to provide a straightness error measurement.

9. The apparatus of claim 7, wherein the third detection device consists of an alignment laser with a cross axis measuring device to provide a straightness error measurement.

10. A movable positioning apparatus for positioning a work piece, which comprises:
a base
one or more linear motors coupled to the base for moving a stage or a work piece relative to the base in a longitudinal direction defined by a substantially longitudinal axis;
first and second detection devices for measuring a longitudinal position at two distant locations along the longitudinal axis;
two actuators coupled to the base or the work piece adapted to move the stage or work piece laterally in relation to the longitudinal axis, each actuator including a motor, a slide, and an encoder to measure the actuators positions, the two actuators being programmed to move either in opposite directions to compensate for a rotation
error or in a same direction to compensate for a lateral error or both simultaneously in the same direction;
a computer adapted to store a map of errors of rotation which include error data verses position data, and the computer using the maps to move the two actuators;
the map of errors of rotation is relative to a longitudinal position measured using an external measuring devise to measure a rotation error relative to a longitudinal position;
a controller which includes a computer and servo amplifiers automatically move the two actuators opposite each other in response to the map of errors of rotation;
a map of lateral errors is relative to a longitudinal position measured using a lateral measuring device to measure a lateral error relative to a longitudinal position; and
a controller which automatically moves the two actuators in a same direction in response to the map of lateral errors.

11. The apparatus of claim 10, wherein the stage is supported by at least three bushings riding on two rails positioned in the longitudinal direction wherein at least two of the bushings ride on one of the two rails;
the two actuators ride on a top surface of two bushings along one rail; and
at least one slide rides on a top surface of a third or more bushings to allow for the lateral displacement of the stage or work piece.

12. The apparatus of claim 10, wherein the stage is supported by at least three air lifters;
two guides ride on substantially rectangular beams positioned in the longitudinal direction, and the two actuators ride on a top surface of the two guides.

13. The apparatus of claim 11, wherein an average of first and second deviations from the first and second detection devices, respectively, is used to move the stage longitudinally using the one or more linear motors.

14. The apparatus of claim 11, wherein a third detection device includes an alignment laser with a cross axis measuring device to provide a straightness error measurement.

15. The apparatus of claim 14, wherein an average of first and second deviations from the first and second detection devices, respectively, is used to move the stage in the longitudinal direction using one or more of the linear motors.

16. The apparatus of claim 12, wherein an average of first and second deviations from the first and second detection devices, respectively, is used to move the stage longitudinally using the one or more linear motors.

17. The apparatus of claim 12, wherein a third detection device consists of an alignment laser with a cross axis measuring device to provide a straightness error measurement.

18. The apparatus of claim 16, wherein a third detection device consists of an alignment laser with a cross axis measuring device to provide a straightness error measurement.

19. A movable positioning apparatus for positioning a work piece, which comprises:
a base;
one or more linear motors coupled to the base for moving one of a stage or work piece relative to the base in a longitudinal direction defined by a substantially longitudinal axis;
a first detection device coupled to the base and communicating with the stage or work piece for detecting a first deviation in a first direction;
one or more of second detection devices coupled to the base and communicating with the stage or work piece for detecting an average of the first deviation; and
one or more actuators coupled to the base and communicating with the stage or work piece for correcting a position of one of the stage or the work piece by the amount of the first deviation, and the actuators move the stage laterally relative to the longitudinal axis, and the actuators provide rotation of the base or work piece by moving in opposite directions.

20. The apparatus of claim 19, wherein the one or more linear motors include two linear motors each coupled to substantially parallel motor rails extending in the longitudinal direction and communicating with a servo controller device to support and move one of the stage or the work piece in the longitudinal direction;
wherein the one or more actuators include at least two actuators which ride along respective substantially parallel rails coupled to the base and extending in the longitudinal direction, the two actuators communicating with the servo controller and adapted to move the stage or cross slides laterally in unison or individually;
wherein one or more of the second detection devices include two encoder devices slidably coupled to respective parallel encoder scales extending in the longitudinal direction and each of the two encoders communicating the position of the work piece to the servo controller which calculates an average position and initiates a corrective movement of the stage or work piece using the actuators by the amount of the first deviation; and
wherein the first detection device includes an alignment laser and detector to measure the first deviation in the first direction and communicates with the servo controller which initiates the corrective movement of the stage or work piece.
